(19) United States
(12) Patent Application Publication
(10) Pub. No.: US 2010/0302362 A1
(43) Pub. Date: Dec. 2, 2010

(54) METHOD AND DEVICE FOR DETECTING WHETHER A VEHICLE HAS EXCEEDED A SPEED LIMIT

(75) Inventors: Josef Alois Birchbauer, Seiersberg (AT); Jurgen Hatzl, Grafenschachen (AT); Marcus Hennecke, Graz (AT)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/747,344

(22) PCT Filed: Nov. 20, 2008
(86) PCT No.: PCT/EP08/65898

§ 371 Date: Aug. 13, 2010

(30) Foreign Application Priority Data
Dec. 10, 2007 (DE) 10 2007 059 346.7

(51) Int. Cl. H04N 7/18; G06K 9/00

(52) U.S. Cl. 348/135; 382/107; 348/E07.091

(57) ABSTRACT

A method for detecting if a vehicle has exceeded a speed limit captures a vehicle feature characterizing a vehicle entering a monitoring section at a first time. A first coding value to be assigned to the vehicle feature is determined by one-way encryption. The vehicle feature of a vehicle leaving the monitoring section is captured at a second time. A second coding value to be assigned to the vehicle feature captured at the second point in time is determined by the one-way encryption. The first and second coding values are compared and if they match, the average speed of the vehicle is determined using the time required to travel through the monitoring section. The average speed is compared to a predefined maximum speed and the vehicle feature is only stored if the average speed exceeds the maximum speed. A corresponding device for carrying out the method is also provided.

The invention relates to a method and an apparatus for capturing a speed violation by a vehicle, wherein a speed violation by the vehicle is captured using an average speed for the vehicle within a monitoring section.

To capture the average speed, such a method—which is also called “section control”—involves the ascertainment of a period of time which a vehicle requires in order to cover the monitoring section, such a monitoring section usually being a relatively long, for example several kilometers long, route section on a highway or being a tunnel section. The ascertained period of time is used to calculate the average speed of the vehicle, which then possibly reveals that the prescribed maximum speed has been exceeded.

A speed violation by a vehicle is ascertained as part of traffic monitoring, for example, in order to monitor compliance with a prescribed maximum speed in road traffic.

A method of the type cited at the outset is known from WO 01 35372 A1, for example. In WO 01 35372 A1, two monitoring stations at a distance from one another are provided for the purpose of capturing the average speed along the monitoring section. A camera is used on the monitoring stations to register when a vehicle enters and leaves the monitoring section. In this case, when the vehicle enters the monitoring section, and when the vehicle leaves the monitoring section, the camera is used to obtain an image of the vehicle and the image is used to ascertain a motor vehicle registration for the vehicle. The ascertained data are stored at least temporarily.

Against the background of the prior art, the invention is based on the object of specifying an alternative method for capturing a speed violation by a vehicle. A further object is to specify an alternative apparatus for capturing a speed violation by a vehicle.

The invention achieves the object directed at a method by means of the combination of features in claim 1.

Accordingly, a vehicle feature which characterizes a vehicle entering a monitoring section is captured at a first time, wherein a one-way encryption method is used to ascertain a first coding value which can be associated with the vehicle feature. The vehicle feature of a vehicle leaving the monitoring section is captured at a second time, wherein the one-way encryption method is used to ascertain a second coding value which can be associated with the vehicle feature captured at the second time. The association of the coding values may be explicit, in particular. The first and second coding values are compared with one another. If the first and second coding values match, an average speed of the vehicle is ascertained using the period of time required in order to cover the monitoring section. The average speed is compared with a prescribed maximum speed, and the vehicle feature is stored only if the average speed is found to have exceeded the maximum speed.

The invention is based on the consideration that capturing a speed violation using an average speed in line with the prior art usually involves a characteristic vehicle feature, such as the motor vehicle registration, being captured and at least temporarily stored for each vehicle which travels through a monitoring section, when entering and leaving the monitoring section. A speed violation cannot be ascertained until the monitoring section is left, which means that the characteristic vehicle feature, for example the motor vehicle registration, has also been collected and temporarily stored when no speed violation occurs, that is to say that the driver has behaved in accordance with the law. This can give rise to legal data-protection reservations, in particular, especially since such a characteristic vehicle feature allows the vehicle in question to be individualized, which also opens up the opportunity to infer personal data relating to a vehicle keeper, in particular.

For this reason, the invention provides for a characteristic vehicle feature to be stored only when a speed violation has actually occurred.

To this end, the invention first of all assigns a first coding value to the vehicle feature captured upon entry at a first time, such that it is no longer possible to infer the vehicle feature on which the coding value is based from the first coding value. To this end, the first coding value is ascertained using a one-way encryption method. Whereas a “normal” encryption method normally allows the relevant unencrypted value to be obtained from the encrypted value if the “key” is known, there is, in simple terms, no “key” in the case of the one-way encryption method. As a result, it is almost impossible to infer the vehicle feature on which the first coding value is based from the first coding value again. If the motor vehicle registration has been captured as the vehicle feature, for example, it is almost impossible to infer the motor vehicle registration from the relevant first coding value again. This property of the one-way encryption method is occasionally referred to as “pre-image resistance”.

The first coding value is associated with the vehicle feature, i.e. each vehicle which enters the monitoring section is provided with a “dedicated” first coding value. The first coding value is at least temporarily stored. The vehicle feature on which the first coding value is based is itself not stored. The entering vehicle is thus subsequently able to be identified not by the characteristic vehicle feature but rather only by the first coding value.

At a second time, the vehicle feature of a vehicle leaving the monitoring section is captured, with a second coding value being assigned to the captured vehicle feature by means of the one-way encryption method. Since both the first and the second coding value is associated with the vehicle feature, it is possible to identify a vehicle traveling through the monitoring section by comparing the relevant coding values. A match between the first and second coding values means that, by way of example, vehicle A, which has entered the monitoring section at the first time, leaves the monitoring section again at the second time. Since the length of the monitoring section is known, the average speed is then obtained from the period of time between the first and second times.

The ascertained average speed is compared with a prescribed maximum speed, for example a “speed limit”. Only if the comparison reveals that the average speed has exceeded the maximum speed is the vehicle feature which was captured for the vehicle leaving the monitoring section stored. This thus means that data which allow the vehicle to be individualized and hence permit the vehicle keeper to be inferred, for example for the purpose of levying a fine, are stored only in the event of a speed being exceeded.

If the maximum speed is found not to have been exceeded, the captured vehicle feature is not stored. In that case, the method does not involve storage of data which, as such, allow the vehicle to be individualized at any time, that is to say neither when entering the monitoring section or when leaving it.

Respective explicit association of the coding values with the vehicle feature characterizing the vehicle rules out any confusion in the identification of a vehicle committing a speed violation. However, even extremely complex coding methods do not entirely rule out what is known as a “collision” occurring between coding values. Such a “collision” occurs when two different vehicle features have the same coding value assigned to them. This could result in comparison of the first and second coding values leading to vehicles being confused, which could sometimes result in a speed violation being unjustifiably found for a vehicle.

In order to prevent such a “collision” between coding values from resulting in a blameless vehicle keeper being unjustifiably prosecuted, one advantageous refinement of the invention provides for an identifying photograph of the entering vehicle (24) to be taken, a further vehicle feature to be captured, the further vehicle feature to be identified to generate a dynamic key, the photograph to be encrypted using the generated dynamic key, the key to be discarded, the further vehicle feature to be captured when the monitoring section is left, the key to be regenerated using the further vehicle feature captured upon exit if the maximum speed is found to have been exceeded, an attempt to be made to decrypt the encrypted photograph using the regenerated key, and the vehicle feature to be stored only if the photograph is decrypted successfully.

In this case, the photograph may comprise the characteristic vehicle feature, in particular. It is also possible for the characteristic vehicle feature and the further vehicle feature to be identical.

By way of example, a photograph of the motor vehicle registration of the entering vehicle is encrypted. The key for this encryption is not “permanent”, but rather is dynamic, i.e. the key is regenerated for each entering vehicle. In this context, the dynamic key is generated particularly on the basis of the further vehicle feature, which in principle may be any vehicle feature, such as a vehicle color or a vehicle shape. Advantageously, however, the motor vehicle registration is also used to generate the key, since this explicitly characterizes any vehicle, which means that particularly the generated key is unique for each vehicle.

When the photograph has been encrypted, the key is erased again, so that unauthorized parties are no longer able to draw on it. Only by identifying the further vehicle feature is the key able to be regenerated and the encrypted photograph able to be decrypted again. Otherwise, the decryption fails.

If the coding values are now used to establish that, by way of example, vehicle A, which is leaving the monitoring section, has committed a speed violation, the successful decryption can be used to rule out any confusion between vehicles. This is because it is the same vehicle only if decryption is successful. Only then is the characteristic vehicle feature stored. Blameless vehicle keepers are therefore not put into a database on account of confusion.

For documentation, a further embodiment of the invention additionally allows the photograph to be stored.

In one preferred refinement of the invention, the first and second coding values are ascertained from the captured vehicle feature by means of a hash algorithm. Such a hash algorithm is generally used for calculating a variance coefficient function, which is also called a hash function. This refers particularly to a cryptographic hash function, which is frequently used for storing passwords, for example. The hash algorithm is used to calculate the relevant coding value as what is known as a hash value. The memory requirement for such a hash value is generally very low, which means that the hash algorithm particularly also allows the rapid and effective processing of large volumes of data.

By way of example, the vehicle feature may be a single visual vehicle feature, such as a motor vehicle registration, a vehicle shape or a color. Similarly, it is possible to capture a combination of different vehicle features or a characteristic audible signal from the vehicle.

Preferably, the vehicle feature captured is a license plate on the vehicle. The license plate makes it a particularly simple matter to characterize the vehicle. In this case, the license plate is captured by means of a camera, for example, so that it is possible to resort to already available surveillance cameras, which are used for other road traffic monitoring, for example.

Advantageously, the motor vehicle registration on the license plate is captured by means of automatic license plate recognition. The license plate normally comprises a multiplicity of features, such as a characteristic shape or color, a country identifier and the motor vehicle registration. However, the motor vehicle registration is normally sufficient to explicitly characterize the vehicle. As a result, it is particularly possible to effectively reduce the volume of data which is to be processed. By way of example, automatic license plate recognition involves the use of optical character recognition (OCR), specifically the use of LPR (License Plate Recognition) or ANPR (Automatic Number Plate Recognition), to automatically ascertain the motor vehicle registration from an image of the vehicle. Automatic license plate recognition is frequently used for monitoring traffic, which means that in this case it is possible to resort to a matured method.

As already explained, the use of the one-way encryption method for generating the first and second coding values makes it almost impossible to “crack” the corresponding coding values in order to infer the respective vehicle feature on which the coding values are based. At the outside, what is known as a “brute-force” attack would provide the opportunity to crack the relevant coding value. In this context, a “brute-force” attack is understood to mean “cracking” the coding value by trying out all the possible solutions. Specifically, this would mean that a “brute-force” attack would involve the relevant coding value being calculated for every motor vehicle registration which is present in an official license plate register, for example, in order to find the motor vehicle registration on which a specific coding value is based. Such a scenario is naturally highly unlikely, since an official license plate register is normally safe from unauthorized access, for example.

In order to ensure, in particular, that the relevant coding values cannot be “cracked” even in the event of such a “brute-force” attack, one particularly advantageous refinement of the invention involves an additional vehicle feature being captured. This means that at least two respective vehicle features are captured at the first and second times. Thus, a combination of vehicle features is captured, for example the motor vehicle registration and an additional vehicle feature. In this case, the first and second coding values are respectively associated with the captured combination of vehicle features. Since a combination of vehicle features is normally not recorded in any database, capturing the additional vehicle feature makes it possible to ensure that even a “brute-force” attack cannot infer the motor vehicle registration, for example, from the relevant coding value. In principle, this refinement of the invention allows any combination of audible and/or visual vehicle features to be captured. Expediently, the motor vehicle registration and an additional vehicle feature are captured.

Advantageously, the additional vehicle feature captured is a visual feature of the vehicle, particularly the color of the vehicle. By capturing the color of the vehicle, particularly in addition to the motor vehicle registration, it is a simple matter to prevent the motor vehicle registration from being ascertained from the coding value by a “brute-force” attack, since the feature combination of motor vehicle registration and vehicle color is not recorded in any database.

The invention achieves the object directed at an apparatus by means of the features of the patent claim which is directed at an apparatus.

Accordingly, the apparatus for capturing a speed violation by a vehicle comprises a first monitoring station and a second monitoring station which is at a distance from the first monitoring station, and also a coding apparatus, a timing apparatus and a computation apparatus. The computation apparatus is connected to the first and second monitoring stations and also to the coding apparatus and the timing apparatus. The first and second monitoring stations each comprise a capturing means which is set up to capture a characteristic vehicle feature of a vehicle entering a monitoring section and of a vehicle leaving the monitoring section. The timing apparatus is set up to capture a first time of entry into the monitoring section and a second time of exit from the monitoring section. The coding apparatus is set up to use a one-way encryption method to ascertain a first and a second coding value from the vehicle features captured by the first and second monitoring stations, and the computation apparatus is set up to ascertain an average speed of the vehicle within the section between the first and second monitoring stations using the time signals from the timing apparatus, and to establish whether a prescribed maximum speed has been exceeded and to store the vehicle feature if said maximum speed is found to have been exceeded.

In this context, the advantages outlined for the method can be transferred mutatis mutandis to the apparatus.

The first monitoring station and the second monitoring station are at a distance from one another, which means that they use their distance from one another essentially to prescribe the length of the monitoring section. The distance between the monitoring stations may be several hundred meters or a few kilometers, for example.

The first and second monitoring stations are each equipped with a capturing means. The capturing means is used to capture a characteristic vehicle feature of a vehicle entering the monitoring section and a vehicle leaving the monitoring section.

In this context, the capturing means may be designed to capture visual and/or audile vehicle features. For the purpose of capturing audible vehicle features, the capturing means comprises a microphone, for example. For the purpose of capturing visual vehicle features, the capturing means expediently comprises a camera, for example a video camera or telephoto lens camera. In this case, such a camera may be positioned such that it records an image of the rear region of the vehicle or an image of another region of the vehicle. In this arrangement, the visual vehicle feature is captured by the photograph as such, for example. Alternatively, the visual vehicle feature is extracted from the photograph by means of an appropriate piece of recognition software, for example, and captured. Capturing the motor vehicle registration from a photograph of the license plate frequently requires only a few milliseconds with the relevant software. For such processing of the photographs, the capturing means comprises an appropriate circuit or is connected to the computation apparatus via an interface, for example.

In order to allow recording of sufficient quality by the camera, the monitoring stations may additionally comprise light sources which illuminate the vehicle. What is advantageous in this context is illumination by an infrared light source in order to allow photographs at night.

Using the vehicle features captured by the first and second monitoring stations, the coding apparatus uses a one-way encryption method to ascertain a first and a second coding value. In this case, the coding apparatus may be implemented in the form of an appropriate circuit or in the form of a piece of software in the computation apparatus, which is provided as a computer, for example. Alternatively, the coding apparatus may be provided as a separate computer.

The timing apparatus is used firstly to capture the first time at which a vehicle enters the monitoring section, that is to say passes the first monitoring station. Secondly, the second time is captured at which the vehicle leaves the monitoring section, that is to say passes the second monitoring station.

In the case of vehicle identification using the coding values, the computation apparatus uses the time signals which the timing apparatus produces in order to ascertain the period of time which the captured vehicle requires in order to cover the section between the first and second monitoring stations. To this end, the computation apparatus synchronizes the time signals received from the timing apparatus, for example.

From the ascertained period of time, the computation apparatus calculates an average speed of the vehicle within the monitoring section by using the length of the monitoring section. The computation apparatus compares the ascertained average speed with a prescribed maximum speed. If the prescribed maximum speed is exceeded, the computation apparatus stores the vehicle feature, that is to say the motor vehicle registration which characterizes the vehicle leaving the monitoring section, for example.

An exemplary embodiment of the invention is explained in more detail with reference to a drawing, in which:

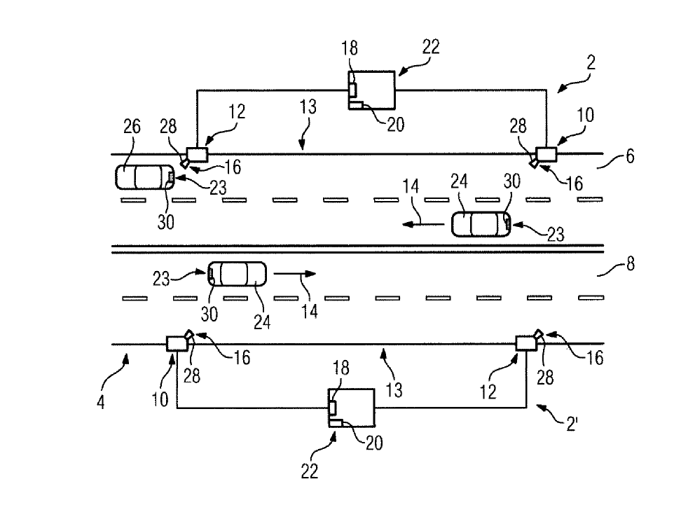

FIG. 1 schematically shows two apparatuses for capturing a speed violation by a vehicle.

The illustration in FIG. 1 shows two apparatuses 2, 2′ for capturing a speed violation which are provided for the purpose of monitoring traffic on a two-line highway 4. As can be seen from the illustration, a respective one of the apparatuses 2, 2′ is provided for the purpose of monitoring one of the two direction carriageways 6, 8.

Each of the apparatuses 2, 2′ comprises two monitoring stations 10, 12 which were at a distance from one another such that the monitoring station 10 is situated before the monitoring station 12 when viewed in the direction of travel 14. This means that the monitoring stations 10, 12 prescribe a monitoring section 13. The distance between the monitoring stations 10, 12 may be several kilometers in this case.

The monitoring stations 10, 12 have a respective associated capturing means 16. In addition, a timing apparatus 18, a coding apparatus 20 and a computation apparatus 22 are provided in each case.

The capturing means 16 is used to capture a vehicle feature characterizing the vehicle 24, 26. In the exemplary embodiment shown, a combination of visual vehicle features, namely a motor vehicle registration 30 on a license plate 23 and additionally a color of the relevant vehicle 24, 26, is captured. For the purpose of capturing the relevant visual vehicle features, the capturing means 16 comprises a camera 28. The camera 28 is used to obtain a photograph of the rear region, which particularly also depicts the license plate 23 of the relevant vehicle 24, 26. From the photograph of the rear region, the vehicle feature, that is to say the motor vehicle registration 30 and the color of the vehicle 24, 26, is then ascertained. In this case, the motor vehicle registration 30 is captured particularly by means of automatic license plate recognition from the photograph.

The feature combination of motor vehicle registration 30 and color of the vehicle 24, 26 which is captured by the capturing means 16 is assigned a first and a second coding value by means of the coding apparatus 20. To this end, the coding apparatus 20 is in the form of an appropriate piece of software of the computation apparatus 22. The first coding value is associated with the captured feature combination from a vehicle 24 entering the monitoring section 13. The second coding value is associated with the captured feature combination from a vehicle 26 leaving the monitoring section 13.

The first and second coding values are each explicitly associated with the captured feature combination. Each vehicle 24, 26 which enters the monitoring section 13 and leaves it is accordingly provided with a “dedicated” first and second coding value. The first and second coding values are respectively ascertained by means of a one-way encryption method. This means that it is virtually impossible to use the first and second coding values to infer the vehicle feature on which said coding values are based again. That is to say that “cracking” the coding values is virtually ruled out. “Cracking” would theoretically be conceivable at the outside by means of a “brute force” attack. The capture of the feature combination of motor vehicle registration 30 and vehicle color effectively prevents the coding values from being “cracked” by a “brute force” attack, since such a feature combination is not recorded in any database.

The explanations below serve to illustrate the manner of operation of the apparatus 2, 2′. To this end, a journey by a vehicle 24, 26 is considered by way of example.

The vehicle 24 entering the monitoring section 13 first of all passes the monitoring station 10 which is at the front in the direction of travel 14 as it enters. The front monitoring station 10 uses its associated capturing means 16 to capture the motor vehicle registration 30 and the color of the entering vehicle 24.

Said feature combination of motor vehicle registration 30 and color of the entering vehicle 24 is assigned a first coding value, which is explicitly associated with the entering vehicle 24, by means of the coding apparatus 20.

In addition, the timing apparatus 18 captures a first time when the vehicle 24 enters the monitoring section 13. By way of example, the timing apparatus 18 is provided as an appropriate electronic circuit of the computation apparatus 20.

When leaving the monitoring section 13, the motor vehicle 26 passes the monitoring station 12 which is at the rear in the direction of travel 14, with the timing apparatus 18 capturing a second time. The capturing means 16 which is associated with the rear monitoring station 12 captures the motor vehicle registration 30 and the color of the vehicle 26 leaving the monitoring section 13.

The coding apparatus 20 assigns a second coding value to the feature combination of motor vehicle registration 30 and color of the leaving vehicle 26.

The second coding value is explicitly associated with said feature combination from the leaving vehicle 26, i.e. each vehicle which leaves the monitoring section 13 is provided with a “dedicated” second coding value. This allows a comparison between the first and second coding values to be used to establish whether the vehicle 26 leaving the monitoring section 13 at the second time is the same as the vehicle 24 entering the monitoring section 13 at the first time. If the first and second coding values match, it is the same vehicle.

In the event of a match, the computation apparatus 22 uses the time signals from the timing apparatus 18 to ascertain the period of time which the vehicle 24, 26 needed in order to cover the monitoring section 13. Using the length of the monitoring section 13, the computation apparatus 22 ascertains the average speed of the vehicle 24, 26 within the monitoring section 13 and compares the ascertained average speed with a prescribed maximum speed. If the average speed exceeds the prescribed maximum speed, the computation apparatus 22 stores the motor vehicle registration 13 of the vehicle 24, 26. In addition, the computation apparatus 22 in this case also stores a photograph which shows the rear region of the relevant vehicle 24, 26.

1.-16. (canceled)

17. A method for capturing a speed violation by a vehicle, the method comprising the following steps:
capturing a vehicle feature characterizing a vehicle entering a monitoring section at a first time;
ascertaining a first coding value to be associated with the vehicle feature by using a one-way encryption method;
capturing the vehicle feature from a vehicle leaving the monitoring section at a second time;
ascertaining a second coding value to be associated with the vehicle feature captured at the second time by using the one-way encryption method;
comparing the first and second coding values with one another;
if the first and second values match, ascertaining an average speed of the vehicle by using a period of time required to cover the monitoring section;
comparing the average speed with a prescribed maximum speed; and
storing the vehicle feature only if the average speed has exceeded the maximum speed.

18. The method according to claim 17, which further comprises:
taking an identifying photograph of the entering vehicle;
capturing a further vehicle feature;
identifying the further vehicle feature to generate a dynamic key;
encrypting the photograph by using the generated dynamic key;
discarding the key;
capturing the further vehicle feature upon leaving the monitoring section;
regenerating the key by using the further vehicle feature captured upon leaving if the maximum speed is found to have been exceeded;
attempting to decrypt the encrypted photograph by using the regenerated key; and
storing the vehicle feature only if the photograph is decrypted successfully.

19. The method according to claim 18, which further comprises storing the vehicle feature and the photograph if the maximum speed has been exceeded and if the encrypted photograph is decrypted successfully.

20. The method according to claim 17, which further comprises ascertaining the first and second coding values from the captured vehicle feature by using a hash algorithm.

21. The method according to claim 17, wherein the captured vehicle feature is a license plate on the vehicle.

22. The method according to claim 21, which further comprises capturing a motor vehicle registration on the license plate by automatic license plate recognition.

23. The method according to claim 17, which further comprises capturing an additional vehicle feature.

24. The method according to claim 23, wherein the additional captured vehicle feature is a visual feature of the vehicle.

25. The method according to claim 24, wherein the visual feature of the vehicle is a color of the vehicle.

26. An apparatus for capturing a speed violation by a vehicle, the apparatus comprising:
first and second monitoring stations being spaced apart from each other and defining a monitoring section therebetweeen, said first and second monitoring stations each including a respective capturing device configured to capture a characteristic vehicle feature of a vehicle entering said monitoring section and a characteristic vehicle feature of a vehicle leaving said monitoring section;
a timing apparatus configured to capture a first time of entry into said monitoring section and a second time of leaving said monitoring section;
a coding apparatus configured to ascertain first and second coding values from the vehicle features captured by said first and second monitoring stations by using a one-way encryption method; and
a computation apparatus connected to said first and second monitoring stations, to said coding apparatus and to said timing apparatus, said computation apparatus configured to:
ascertain an average speed of the vehicle within said monitoring section between said first and second monitoring stations by using time signals from said timing apparatus,
establish if a prescribed maximum speed has been exceeded, and
store the vehicle feature if said maximum speed has been exceeded.

27. The apparatus according to claim 26, wherein:
said capturing device is configured to take an identifying photograph of the entering vehicle and to capture a further vehicle feature upon entry and upon leaving;
said coding apparatus is configured to identify the further vehicle feature to generate a dynamic key, to encrypt the photograph using the generated dynamic key, to discard the key, to regenerate the key using the further vehicle feature captured upon leaving if the maximum speed has been exceeded, and to decrypt the encrypted photograph using the regenerated key; and
said computation apparatus is configured to store the vehicle feature only if the photograph is decrypted successfully.

28. The apparatus according to claim 27, wherein said computation apparatus is configured to additionally store the photograph if the maximum speed has been exceeded and if decryption is successful.

29. The apparatus according to claim 26, wherein said coding apparatus is configured to ascertain said first and second coding values by using a hash algorithm.

30. The apparatus according to claim 26, wherein said capturing device is configured to capture a license plate on the vehicle as a vehicle feature.

31. The apparatus according to claim 30, wherein said capturing device is configured to capture a motor vehicle registration on the license plate by using automatic license plate recognition.

32. The apparatus according to claim 26, wherein said capturing device is configured to capture an additional vehicle feature.

33. The apparatus according to claim 31, wherein said capturing device is configured to capture a visual feature of the vehicle as an additional vehicle feature.

34. The apparatus according to claim 33, wherein the additional vehicle feature is a color of the vehicle.
